(19) United States
(12) Patent Application Publication
(10) Pub. No.: US 2012/0139510 A1
(43) Pub. Date: Jun. 7, 2012

(54) TAP CHANGER WITH VACUUM SWITCH TUBES

(76) Inventor: Silke Wrede, Zeitlarn (DE)

(21) Appl. No.: 13/390,402

(22) PCT Filed: Jun. 12, 2010
(86) PCT No.: PCT/EP2010/003554

§ 371 Date: Feb. 16, 2012

(30) Foreign Application Priority Data
Sep. 26, 2009 (DE) 10 2009 043 171.3

(51) Int. Cl. G05F 1/16

(52) U.S. Cl. 323/258

(57) ABSTRACT

The invention relates to a stepping switch comprising vacuum switching tubes. The general inventive concept consists in providing one or more cam disks which have profiled circumferential contours both on the upper or lower face as well as on the lateral face, said contours being in the shape of cams for example, so that the vacuum switching tubes can be actuated by both the profiled circumferential contour of the lateral face as well as by the contour of the upper or lower face.

The invention relates to a tap changer with vacuum switching tubes according to the preamble of the first patent claim.

Tap changers have been in worldwide use in large numbers for many years for uninterrupted switching over between different winding taps of tapped transformers. Such tap changers usually consist of a selector for power-free selection of the respective winding tap of the tapped transformer which is to be switched over to and a load changeover switch for the actual switching over from the connected to the new, preselected winding tap. The abrupt switching over is usually carried out with the assistance of a force store, on the triggering of which a switching shaft is rapidly rotated. The load changeover switch in addition usually comprises switch contacts and resistance contacts. The switch contacts in that case serve for direct connection of the respective winding tap with the load shunt and the resistance contacts for temporary connection, i.e. bridging-over by means of one or more switch-over resistances.

Such a load changeover switch of a tap changer, which uses vacuum switching tubes for uninterrupted switching-over, is known from DE 195 10 809 [U.S. Pat. No. 5,834,717]. In that case, a respective cam disk is provided for each switching element to be actuated and each movement direction of the drive shaft. The respective wall surfaces of the individual cam disks have a defined profile which departs from a circular shape and by means of which on rotation of the switching shaft individual vacuum switching tubes or also mechanical contacts are actuated.

In DE 42 31 353 the actuation of the individual vacuum switching tubes takes place through a switching shaft which is rotatable in both directions and which is rapidly rotated after triggering of a force store. In that case, fixedly arranged on the switching shaft for actuation of the vacuum switching tubes is a cam disk which has at its wall surface for each vacuum switching tube a control cam in which a roller, which acts on the actuating lever of the associated vacuum switching tube, is constrainedly guided in mechanically positive manner. The control cam is here realized in the form of a horizontal encircling groove which departs from the circular profile and in which the respective roller mechanically positively engages.

In addition, a load changeover switch operating in accordance with the reactor principle is known from DE 40 11 019 C1, in which the cam disk for actuation of the contacts does not have a profile departing at the encircling wall surface from a circular shape, but possesses on the upper side and lower side thereof grooves with geometrically different shape. A double-sided actuation of different switching elements with a different switching sequence is possible with this known solution.

A disadvantage of these known solutions is the large space requirement of the plurality of cam disks, since a respective separate cam disk is needed for actuation of each individual vacuum switching tube. This problem is particularly relevant when for realization of the switching sequence a larger number of vacuum switching tubes per phase is incorporated in the load changeover switch. The available installation space within the load changeover switch is often then no longer sufficient in the known solutions and constructionally disadvantageous compromise solutions have to be adopted.

It is accordingly the object of the invention to provide a tap changer with vacuum switching tubes of the kind stated in the introduction in which the one or more cam disks occupy only a small amount of installation space within the load changeover switch notwithstanding a plurality of switch contacts to be actuated.

According to the invention this object is fulfilled by a tap changer with vacuum switching tubes with the features of the first patent claim. The subclaims relate to particularly preferred embodiments of the invention.

The general inventive idea consists in providing one or more cam disks which have not only on the upper side or lower side, but also on the wall surface profiled encircling contours, for example in the form of cams, so that electrical contacts, for example vacuum switching tubes, are actuatable by both the profiled encircling contour of the wall surface and the upper side or lower side. According to the invention several regions of the surface of one or more cam disks are thus provided for actuation of different electrical contacts with different switching sequences.

Through the solution in accordance with the invention it is now possible for the first time to actuate a plurality of vacuum switching tubes when only a small installation space is available, in that the individual rollers, which, for example, co-operate by means of a rocker lever with the vacuum switching tubes, are brought into engagement with the respectively co-operating control cam of the cam disk no longer just at the upper side or lower side of the corresponding cam disk or alternatively at the wall surface thereof, but with a combination of the two sides or even all three sides, thus a combination of upper side, lower side and wall surface. This has the consequence of a very compact overall mode of construction of the cam disk, a reduction in the components needed and thus a saving of space within the load changeover switch.

The invention shall be explained in more detail by way of example in the following on the basis of drawings, in which:

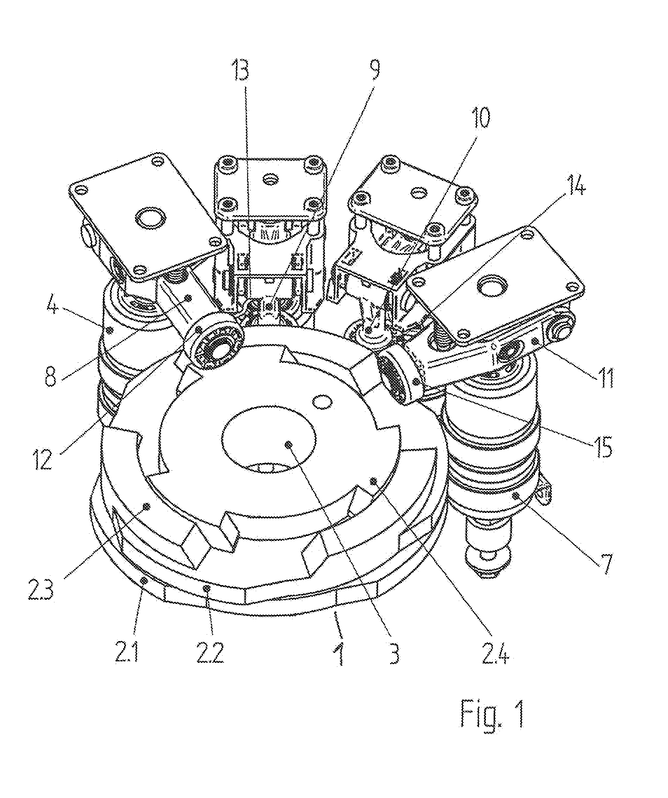

FIG. 1 shows a schematic illustration of a part of a tap changer according to the invention with vacuum switching tubes,

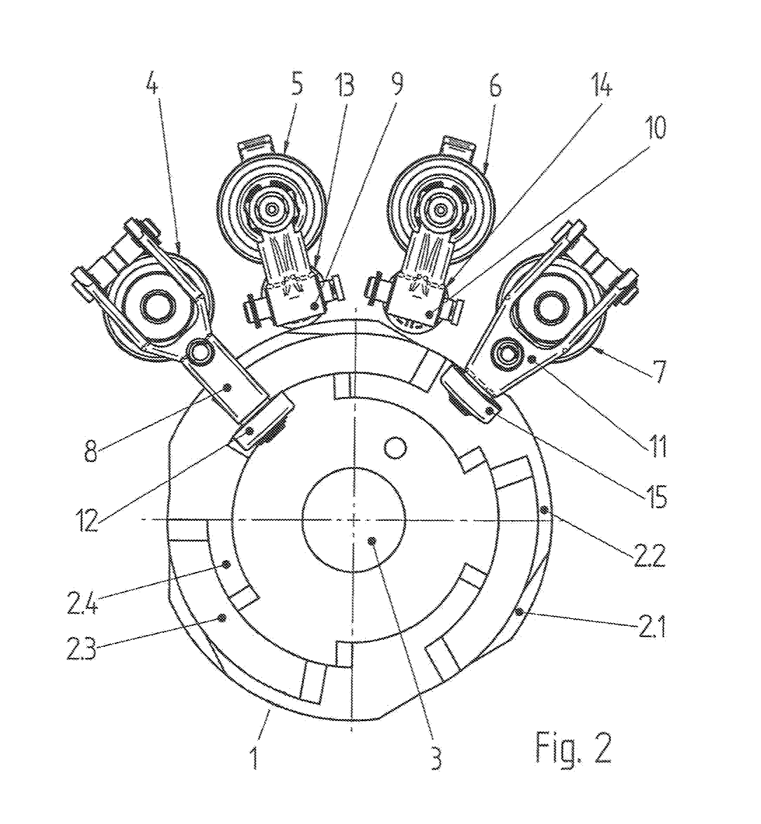

FIG. 2 shows a plan view of a part of a tap changer according to the invention with vacuum switching tubes and

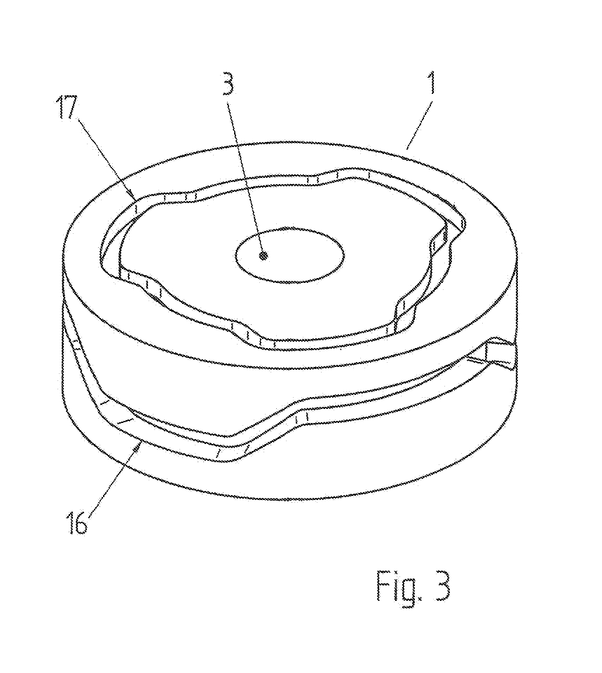

FIG. 3 shows a preferred form of embodiment of a tap changer according to the invention with vacuum switching tubes.

For reasons of clarity only those parts of a tap changer according to the invention with vacuum switching tubes that are essential to the invention are illustrated and described in the following in FIG. 1. The description and illustration of features which are known per se and components not relevant to the essence of the invention was dispensed with. Accordingly, FIG. 1 shows a form of embodiment of a cam disk 1 with a plurality of control cams 2.1, 2.2, 2.3 and 2.4 which in their co-operation control the switching sequence in time of a contact system for the switching-over of a tap changer and are suitable for actuation of a plurality of vacuum switching tubes. The two control cams 2.1 and 2.2 arranged on the wall surface of the cam disk 1 have in that case a contour, which departs from a circular shape, in the form of cams, on which are guided, with constrained maintenance of contact, respective rollers 13 and 14 connected by way of rocker levers 9 and 10 with respective vacuum switching tubes (not visible in this illustration), which rollers engage the profiled contours of the respective control cams 2.1 and 2.2. Since the rollers 13 and 14 employed here serve the purpose of engaging the surface topology of the contour departing from a circular shape they can also be replaced by other sliding elements have equivalent effect, for example spring-loaded pins. In addition, the width of the wall surface of the control cam 1 is used for the purpose of providing more than only one control cam there. However, it would obviously also be possible to restrict to only one control cam at the wall surface.

The function and positioning of the rollers, rocker levers and vacuum switching tubes are explained in more detail in FIG. 2. Mounted on the upper side of the cam disk 1 are two further control cams 2.3 and 2.4, similarly with encircling cams, which co-operate with corresponding rollers 12 and 15, which are fastened to rocker levers 8 and 11, with vacuum switching tubes 4 and 5. In addition, it would also be readily capable of technical realization to mount the control cams 2.3 and 2.4 on the lower side of the cam disk 1. The height profiling, which is provided on the control cams 2.3 and 2.4, in the manner of encircling cams consists of tracks arranged substantially concentrically with respect to one another. In that case the height profile of the control cam 2.4 is somewhat thicker by comparison with that of the control cam 2.3 so that in the case of rotation of the cam disk 1 neither of the rollers 12 and 15 respectively engaging the height profiles of the corresponding control cams 2.3 and 2.4 collides with the height profile of the respective other control cam. In this mode and manner it is also possible to provide on the upper side or lower side of the cam disk 1 more than the two control cams 2.3 and 2.4 illustrated in FIG. 1.

In the case of the cam disk 1 according to the invention profiled encircling contours, for example in the form of cams, are provided not only on the upper side or lower side, but also on the wall surface so that different electrical contacts, for example in the form of vacuum switching tubes, are actuatable by both the profiled encircling contour of the wall surface and the upper or lower side. The encircling contours at the front face as well as the upper or lower side can also be termed cam tracks. The angle of incidence of the respective cams can be selected within wide limits and extends from a very acute angle to an approximate right angle. It is also possible to form the individual cams with a flowing transition in the manner of waves. Formed centrally in the interior of the substantially rotationally symmetrical cam disk 1 is a passage opening 3 through which a switching shaft (not illustrated) is guided, which shaft is disposed in fixed connection with the cam disk 1 and by means of which the cam disk 1 can be set in rotation. In summary, there is thus illustrated in FIG. 1 a single cam disk 1 which by way of a plurality of control cams 2.1 to 2.4 provided thereon enables space-saving actuation of a plurality of vacuum switching tubes 4 to 7.

It is also conceivable within the scope of the invention to arrange a plurality of cam disks with displacement in the axial direction of the switching shaft (not illustrated), thus one above the other. Profiled contours, for example in the form of cam tracks, could then be arranged at each individual cam disk not only on the upper side or lower side, but also on the wall surface as described and more closely illustrated in FIG. 1 and thus, if required, an even greater number of vacuum switching tubes could be actuated in simple manner.

FIG. 2 shows a plan view of a part of a tap changer according to the invention with vacuum switching tubes. The vacuum switching tubes 4, 5, 6 and 7 are so positioned with respect to the cam disk 1 that they are actuatable in the most space-saving manner possible by means of the rocker levers 8, 9, 10 and 11 and rollers 12, 13, 14 and 15 co-operating therewith. The rollers 12 and 15 then engage, in the case of rotation of the cam disk 1, the surface topologies of the encircling cams of the respective control cams 2.3 and 2.4 and actuate, according to the respective transiting surface profile, the corresponding cooperating vacuum switching tube 4 or 7. Accordingly, the rollers 13 and 14 then engage, in parallel therewith, the contours, which at the two wall-surface control cams 2.1 and 2.2 depart from a circular shape, in the manner of cams and actuate the respectively cooperating vacuum switching tubes 5 and 6.

The cam disk 1 illustrated in FIGS. 1 and 2 is of integral construction and with particular preference consists in addition of electrically insulating materials. However, in the alternative it is also conceivable for the cam disk 1 to be of multi-part construction, for example in such a manner that each cam disk 2.1 to 2.4 is a separately produced component which only subsequently to the production process is assembled into a cam disk 1, or the separately produced components are individually plugged onto the switching shaft (not illustrated).

By contrast to FIGS. 1 and 2, in FIG. 3 the encircling profiled contours for actuation of the plurality of vacuum switching tubes are not constructed as cam tracks departing from a circular shape, but as encircling grooves 16 and 17 which are arranged on the upper or lower side as well as the wall surface and in the profile of which the respective cooperating rollers engage and are constrainedly guided therein on rotation of the cam disk 1. Thus, also in FIG. 3 as in accordance with the general inventive idea several regions of the surface of one or more cam disks are provided for actuation of different electrical contacts, such as, for example, vacuum switching tubes (which are not further illustrated in this FIG. 3), with different switching sequences.

### REFERENCE NUMERAL LIST

1 cam disk

2.1 control cam

2.2 control cam

2.3 control cam

2.4 control cam

3 passage opening

4 vacuum switching tube

5 vacuum switching tube

6 vacuum switching tube

7 vacuum switching tube

8 rocker lever

9 rocker lever

10 rocker lever

11 rocker lever

12 roller

13 roller

14 roller

15 roller

16 groove

17 groove

1-11. (canceled)

12. A tap changer with vacuum switching tubes, consisting of a selector for power-free selection of the respective winding tap of the tapped transformer which is to be switched over to and a load changeover switch for the actual switching over from the connected to the new, preselected winding tap, wherein
the load changeover switch comprises a rotatable switching shaft carrying a cam disk,
the vacuum switching tubes are actuatable by actuating elements which in turn cooperate with a contour on the cam disk,
the cam disk has mutually separate control cams at its wall surface and additionally at its upper surface,
at least two separate cams each with a cam contour differing from a circular shape are provided at the wall surface of the cam disk to extend parallel to one another,
at least two further separate control cams, which are arranged concentrically with one another about the axis of rotation of the cam disk and which each have a profiling in height, are provided at the upper side of the cam disk,
at least four vacuum switching tubes are provided,
each vacuum switching tube has a rocker lever for contact actuation with a roller at the respective end, and
each roller runs independently on an individual control cam.

13. The tap changer defined in claim 12, wherein all control cams are arranged on a single cam disk formed as a constructional unit.

13. The tap changer defined in claim 12, wherein a plurality of cam disks formed as a constructional unit is arranged on the common switching shaft.
